(19) United States
(12) Patent Application Publication
(10) Pub. No.: US 2021/0288338 A1
(43) Pub. Date: Sep. 16, 2021

(54) FUEL CELL AND METHOD FOR PRODUCING FUEL CELL

(71) Applicant: TOYOTA JIDOSHA KABUSHIKI KAISHA, Toyota-shi (JP)

(72) Inventors: Nobuaki NONOYAMA, Chiryu-shi (JP); Motohiro TSUZUKI, Susono-shi (JP)

(73) Assignee: TOYOTA JIDOSHA KABUSHIKI KAISHA, Toyota-shi (JP)

(21) Appl. No.: 17/186,890

(22) Filed: Feb. 26, 2021

(30) Foreign Application Priority Data
Mar. 12, 2020 (JP) 2020-042570

(51) Int. Cl. H01M 8/0273; H01M 8/1004

(52) U.S. Cl. CPC H01M 8/0273; H01M 8/1004

(57) ABSTRACT

A fuel cell includes a membrane electrode assembly having a first and second catalyst layers, and an electrolyte membrane between the first and the second catalyst layers, a support frame around the membrane electrode assembly, a first gas diffusion layer arranged in contact with the first catalyst layer and beyond an outer edge of the membrane electrode assembly, a second gas diffusion layer arranged in contact with the second catalyst layer, a pair of separators holding the first and second gas diffusion layers, and the support frame, and a cover sheet provided continuously from a first area between the first gas diffusion layer and the support frame to a second area between the first gas diffusion layer and the electrolyte membrane or the first catalyst layer, and does not transmit reaction gas. The cover sheet is adhered to the support frame and the electrolyte membrane through an adhesive layer.

### CROSS REFERENCE TO RELATED APPLICATIONS

The present application claims the priority based on Japanese Patent Application No. 2020-42570 filed on Mar. 12, 2020, the disclosure of which is hereby incorporated by reference in its entirety.

### BACKGROUND

### Field

The present disclosure relates to a fuel cell and a method of producing a fuel cell.

### Related Art

Conventionally, there exists a technology of a solid polymer type fuel cell including a membrane electrode structure. In the technology of Japanese Patent No. 5681792, the electrolyte membrane-electrode structure includes a solid polymer electrolyte membrane, an anode side electrode, and a cathode side electrode. The anode side electrode is arranged on one surface of the solid polymer electrolyte membrane. The cathode side electrode is arranged on the other surface of the solid polymer electrolyte membrane. The cathode side electrode exposes the outer peripheral part of the solid polymer electrolyte membrane. The electrolyte membrane-electrode structure surrounds the outer periphery of solid polymer electrolyte membrane, and includes a resin frame member joined to only the cathode side electrode. The resin frame member includes an impregnation portion formed by impregnating the outer marginal portion of the gas diffusion layer of the cathode side electrode with the inner marginal portion.

In the above-described technology, the resin frame member is joined directly to the gas diffusion layer of the cathode side electrode. Thus, in the production process of a fuel cell after joining the resin frame member and the gas diffusion layer of the cathode side electrode, or during the operation of a produced fuel cell, (i) the gas diffusion layer of the cathode side electrode joined to the inner side of the resin frame member or (ii) the membrane electrode structure joined to the gas diffusion layer may be damaged due to a difference in thermal expansion of the components or force imposed from the outside.

The present disclosure is made to address the above-described problems, and may be achieved by the following forms.

### SUMMARY

One aspect of the disclosure provides a fuel cell. The fuel cell includes a membrane electrode assembly that has a first catalyst layer, a second catalyst layer, and an electrolyte membrane arranged between the first catalyst layer and the second catalyst layer, a support frame that is arranged around the membrane electrode assembly, a first gas diffusion layer that is arranged to be in contact with the first catalyst layer and is at least partially arranged beyond an outer edge of the membrane electrode assembly, a second gas diffusion layer that is arranged to be in contact with the second catalyst layer, a pair of separators that hold the first gas diffusion layer, the second gas diffusion layer, and the support frame, and a cover sheet that is provided continuously from a first area between the first gas diffusion layer and the support frame to a second area between the first gas diffusion layer and the electrolyte membrane or the first catalyst layer, and does not transmit reaction gas of the fuel cell, in which the cover sheet is adhered to the support frame and the electrolyte membrane through an adhesive layer so as not to transmit the reaction gas.

### BRIEF DESCRIPTION OF DRAWINGS

FIG. 1 is a section view illustrating a schematic structure of a fuel cell.

FIG. 2 is an expanded view of FIG. 1.

FIG. 3 is a processing flow illustrating an example of a production method of a fuel cell.

FIG. 4 is an explanatory diagram of application processing.

FIG. 5 is an explanatory diagram of arrangement processing.

FIG. 6 is an explanatory diagram of holding processing.

FIG. 7 is a section view illustrating a schematic structure of a fuel cell according to the second embodiment.

FIG. 8 is a processing flow of a production method of a fuel cell according to the second embodiment.

FIG. 9 is an explanatory diagram of application processing according to the second embodiment.

FIG. 10 is an explanatory diagram of second arrangement processing according to the second embodiment.

FIG. 11 is an explanatory diagram of holding processing according to the second embodiment.

FIG. 12 is an explanatory diagram of a fuel cell according to another embodiment.

FIG. 13 is an explanatory diagram of a fuel cell according to a referential example.

### DETAILED DESCRIPTION

### A. First Embodiment

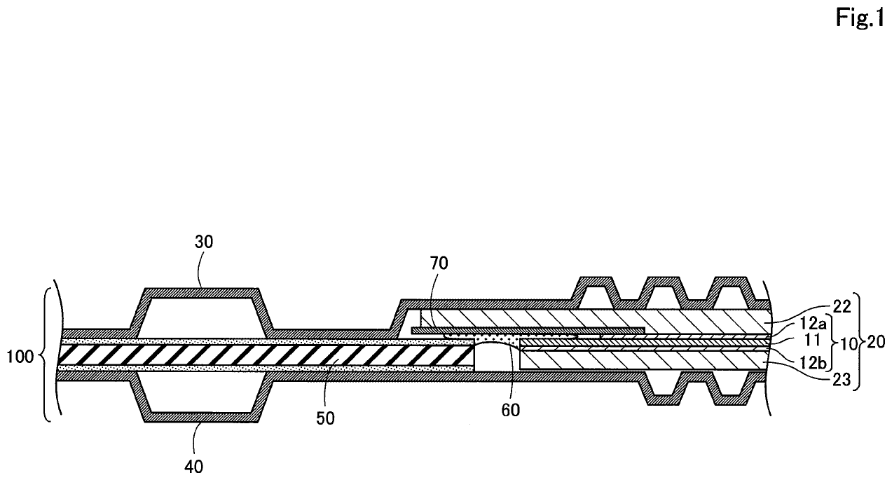

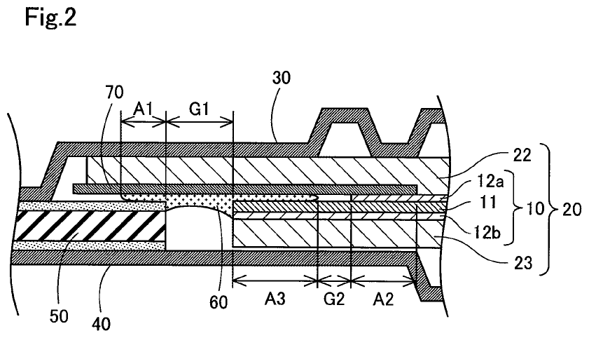

FIG. 1 is a section view illustrating a schematic structure of a fuel cell 100 according to an embodiment of the disclosure. FIG. 2 is an expanded view of FIG. 1. The fuel cell 100 is a solid polymer type fuel cell that receives supply of hydrogen and oxygen as reaction gas and generates power. The fuel cell 100 includes a membrane electrode assembly 10, a pair of gas diffusion layers 22, 23, a pair of separators 30, 40, a support frame 50, an adhesive layer 60, and a cover sheet 70.

The membrane electrode assembly 10 includes a first catalyst layer 12a, the second catalyst layer 12b, and an electrolyte membrane 11 arranged between the first catalyst layer 12a and the second catalyst layer 12b. The electrolyte membrane 11 is a solid polymer thin film exhibiting preferable proton conductivity in a wet state. The electrolyte membrane 11 is formed by a fluororesin ion exchange membrane. The first catalyst layer 12a and the second catalyst layer 12b contain a catalyst accelerating chemical reaction of hydrogen and oxygen and carbon particles carrying the catalyst. In the embodiment, the outer marginal portion of the first catalyst layer 12a is positioned on the inner side than the outer marginal portion of the electrolyte membrane 11, when viewed in the vertical direction relative to the thickness direction of the fuel cell 100.

The gas diffusion layers 22, 23 are formed to be adjacent to both surfaces of the membrane electrode assembly 10. To be more specific, the first gas diffusion layer 22 is arranged to be in contact with the first catalyst layer 12a, and is provided at least partially beyond the outer edge of the membrane electrode assembly 10, when viewed in the vertical direction relative to the thickness direction of the fuel cell 100. Moreover, the second gas diffusion layer 23 is arranged to be in contact with the second catalyst layer 12b. The gas diffusion layers 22, 23 are layers that diffuse reaction gas used in electrode reaction along a surface direction of the electrolyte membrane 11, and are formed by a porous diffusion substrate. As the diffusion substrate, there is used a porous substrate having conductivity and gas diffusion property such as a carbon fiber substrate, a graphite fiber substrate, or foamed metal. The membrane electrode assembly 10, the first gas diffusion layer 22, and the second gas diffusion layer 23 are collectively referred to as a membrane electrode structure 20.

The separators 30, 40 hold the membrane electrode structure 20 and the support frame 50. To be more specific, the first separator 30 is arranged to be adjacent to the opposite surface of the membrane electrode assembly 10 side of the first gas diffusion layer 22. Moreover, the second separator 40 is arranged to be adjacent to the opposite surface of the membrane electrode assembly 10 side of the second gas diffusion layer 23. The separators 30 40 are formed by press-molding a metal plate made of stainless steel, titanium, or an alloy thereof, or a carbon resin composite, for example.

The support frame 50 is arranged around the membrane electrode assembly 10. In the embodiment, the support frame 50 is arranged to keep a given gap G1 from the membrane electrode assembly 10 and the second gas diffusion layer 23. As the support frame 50, there may be used an insulating film member made of resin such as polypropylene, polyphenylene sulfide, or polyethylene naphthalate, for example. The support frame 50 functions as a sealing member to prevent a leak of reaction gas to the outside of the fuel cell 100.

The cover sheet 70 is continuously provided from the first area A1 to the second area A2. The first area A1 is an area expanding in the surface direction between the first gas diffusion layer 22 and the support frame 50 in the thickness direction of the fuel cell 100. The second area A2 is an area expanding in the surface direction between the first gas diffusion layer 22 and the first catalyst layer 12a in the thickness direction of the fuel cell 100. In the embodiment, the outer marginal portion of the first catalyst layer 12a is positioned on the inner side than the outer marginal portion of the electrolyte membrane 11. Therefore, the cover sheet 70 is provided to also cover the third area A3. The third area A3 is an area expanding in the surface direction between the gas diffusion layer 22 and the electrolyte membrane 11 in the thickness direction of the fuel cell 100. Note that the end portion on the membrane electrode assembly 10 side of the cover sheet 70 only needs to be arranged on the electrolyte membrane 11 or the first catalyst layer 12a. In a case where the outer marginal portion of the first catalyst layer 12a exists onto the outer marginal portion of the electrolyte membrane 11, the cover sheet 70 is provided to the area between the inner part than the outer marginal portion of the first gas diffusion layer 22 and the first catalyst layer 12a. The cover sheet 70 is provided using a member not transmitting reaction gas of the fuel cell 100. The member not transmitting reaction gas may be a film member made of resin such as polypropylene, polyphenylene sulfide, or polyethylene naphthalate, for example. Moreover, the cover sheet 70 may be a resin film containing an adhesive component. The cover sheet 70 is mutually adhered to the support frame 50 and the electrolyte membrane 11 through an adhesive layer 60 so as not to transmit reaction gas.

The adhesive layer 60 is a layer of an adhesive formed on the surface on the opposite side of the separator 30 of the cover sheet 70. In the embodiment, the adhesive layer 60 is provided continuously from an area between the cover sheet 70 and the support frame 50 to an area between the cover sheet 70 and the electrolyte membrane 11. To be more specific, the adhesive layer 60 is arranged on the surface facing the first area A1 of the cover sheet 70, the surface facing the gap G1 of the cover sheet 70, and the surface facing the third area A3 of the cover sheet 70. The adhesive layer 60 does not transmit reaction gas in the fuel cell 100. The adhesive may be a thermosetting adhesive or a UV thermosetting adhesive, for example.

In the embodiment, the adhesive layer 60 is arranged on the surface facing the third area A3 of the cover sheet 70 with a given gap G2 from the first catalyst layer 12a. The contact between the adhesive and the first gas diffusion layer 22 may cause catalyst poisoning due to chemical reaction and deteriorate the first gas diffusion layer 22. Therefore, it is preferable to provide the gap G2 between the adhesive layer 60 and the first catalyst layer 12a.

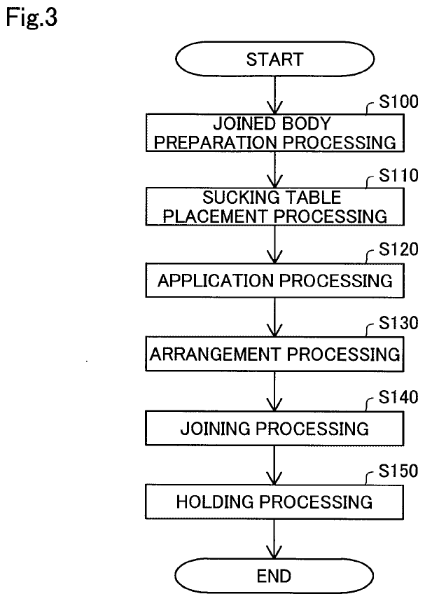

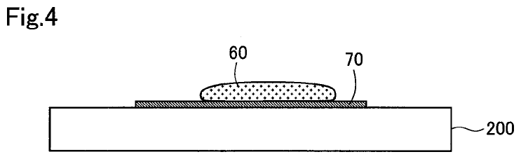

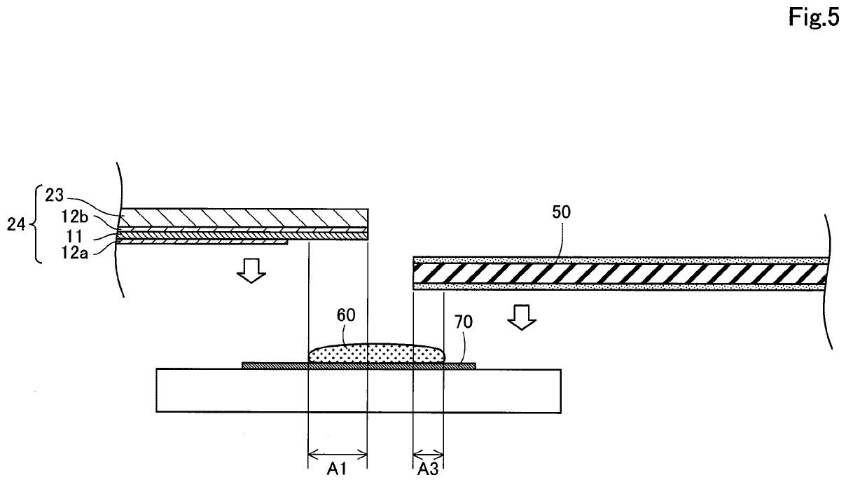

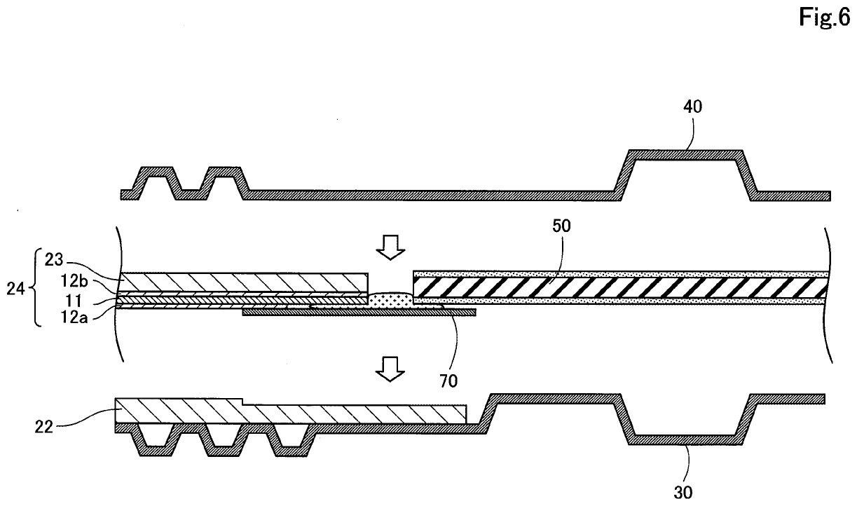

FIG. 3 is a processing flow illustrating an example of the production method of the fuel cell 100. FIG. 4, FIG. 5, and FIG. 6 are explanatory diagrams of several processing in the production method. First, joined body preparation processing is performed at Step S100. The “joined body preparation processing” is processing for preparing a joined body 24 including the second gas diffusion layer 23, the second catalyst layer 12b, the electrolyte membrane 11, and the first catalyst layer 12a (see FIG. 4). The joined body 24 is prepared by joining the second gas diffusion layer 23, the second catalyst layer 12b, the electrolyte membrane 11, and the first catalyst layer 12a, for example.

Next, sucking table placement processing is performed at Step S110. The “sucking table placement processing” is processing for placing the cover sheet 70 on a sucking table 200. The sucking table 200 is a device capable of sucking a structure placed on the sucking table 200 by vacuum sucking or the like.

Next, application processing is performed at Step S120. The “application processing” is processing for applying an adhesive. FIG. 4 is an explanatory diagram illustrating the application processing. As illustrated in FIG. 4, in the application processing of the embodiment, an adhesive for forming the adhesive layer 60 is applied onto the upper surface of the cover sheet 70. The adhesive is applied by a dispenser, for example.

Subsequently, arrangement processing is performed at Step S130. The “arrangement processing” is processing for arranging the joined body 24 and the support frame 50 on the adhesive applied onto the cover sheet 70 at Step S120. FIG. 5 is an explanatory diagram of the arrangement processing. As illustrated in FIG. 5, the joined body 24 and the support frame 50 are arranged on the adhesive applied on the cover sheet 70 so that the adhesive layer 60 is provided at the area to be the first area A1 and the area to be the third area A3.

Next, joining processing is performed at Step S140. The “joining processing” is processing for joining the joined body 24 and the support frame 50 on the sucking table 200, and the cover sheet 70. For example, ultraviolet (UV) irradiation is performed from the side of the joined cover sheet 70, whereby the adhesive applied at Step 120 is hardened. As a result, the adhesive layer 60 is formed, and the joined body 24 and the support frame 50, and the cover sheet 70 are joined. In a case where the sucking table 200 is made of a material transmitting UV, UV irradiation is performed through the sucking table 200 for joining. Moreover, UV irradiation may be performed from the lower surface by lifting the joined body 24 and the support frame 50 from the sucking table 200 by a plane surface sucking pad or the like.

Finally, holding processing is performed at Step S150. The “holding processing” is processing for holding the joined body 24, the support frame 50, the cover sheet 70, and the first gas diffusion layer 22 by a pair of separators 30, 40. FIG. 6 is an explanatory diagram of the holding processing. As illustrated in FIG. 6, the support frame 50, the joined body 24, and the cover sheet 70 joined at Step S140 are arranged on the first separator 30 to which the first gas diffusion layer 22 is joined, and the second separator 40 is arranged and joined thereon. For example, thermocompression bonding is performed, so as to melt the support frame 50 to be joined to the first separator 30 and the second separator 40. Moreover, thermocompression bonding is performed, so as to soften the cover sheet 70 as well to be fixed to the first gas diffusion layer 22 by anchor effect. The “anchor effect” is an effect for increasing adhesiveness by a certain material entering unevenness or cavities on a surface of another material.

In the above-described fuel cell 100 of the embodiment, the support frame 50 is arranged around the membrane electrode assembly 10. Then, the cover sheet 70 is adhered to the support frame 50 and the membrane electrode assembly 10 through the adhesive layer 60 (see FIG. 1 and FIG. 2). Therefore, as compared with the form in which the support frame 50 and the first gas diffusion layer 22 are adhered directly, the gas diffusion layer 22, the electrolyte membrane 11, and the membrane electrode structure 20 are less likely to be damaged due to a difference in thermal expansion of the components and force added from the outside in the production process of the fuel cell 100 or during the operation of the fuel cell 100. This prevents deterioration of the fuel cell 100.

Moreover, the cover sheet 70 not transmitting reaction gas is adhered to the electrolyte membrane 11 of the membrane electrode assembly 10 and the support frame 50 so as not to transmit reaction gas (see FIG. 1 and FIG. 2). In this manner, it is possible to present mixture of reaction gas on the first catalyst layer 12a side and reaction gas on the second catalyst layer 12b side.

Moreover, the gap G1 is provided between the support frame 50 and the membrane electrode assembly 10 (see FIG. 1 and FIG. 2), which prevents overlapping of the support frame 50 and the membrane electrode assembly 10 in the production process of the fuel cell 100. In this manner, it is possible to prevent damages of the support frame 50 and the membrane electrode assembly 10. Moreover, it is possible to prevent an increase of the thickness of the fuel cell 100.

Moreover, the support frame 50, the electrolyte membrane 11, and the first catalyst layer 12a are adhered by the cover sheet 70 (see FIG. 1 and FIG. 2). In this manner, the cover sheet 70 covers a part not covered by the first catalyst layer 12a in the electrolyte membrane 11. Therefore, it is possible to prevent sticks of foreign substances into the electrolyte membrane 11, and prevent a rupture of the membrane electrode assembly 10. This prevents deterioration of the fuel cell 100.

Moreover, the adhesive layer 60 not transmitting reaction gas is continuously provided from the area between the cover sheet 70 and the support frame 50 to the area between the cover sheet 70 and the electrolyte membrane 11 (see FIG. 1 and FIG. 2). Therefore, the adhesive layer 60 and the cover sheet 70 are provided in the area A1, the gap G1, and the third area A3 (see FIG. 1 and FIG. 2). In this manner, the layer not transmitting reaction gas is doubled, which further prevents mixtures of reaction gas on the first catalyst layer 12a side and reaction gas on the second catalyst layer 12b side. For example, even if foreign substances or fibers stick in the adhesive layer 60 through the gap G1 between the support frame 50 and the membrane electrode assembly 10, the cover sheet 70 prevents an inflow of reaction gas from the first gas diffusion layer 22.

### B. Second Embodiment

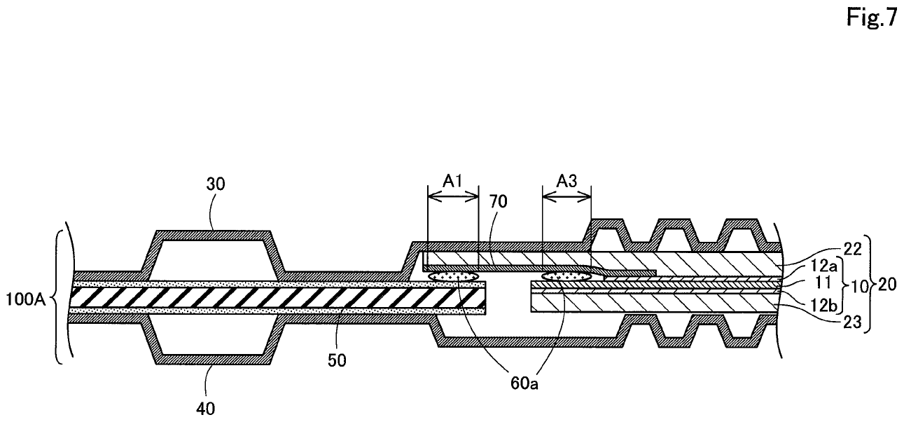

FIG. 7 is a section view illustrating a schematic structure of a fuel cell 100A according to the second embodiment. The fuel cell 100A is different from the first embodiment in the aspect that an adhesive layer 60a is arranged only on the surface facing the first area A1 of the cover sheet 70 and the surface facing the third area A3 of the cover sheet 70, and the other structures are same as those of the first embodiment.

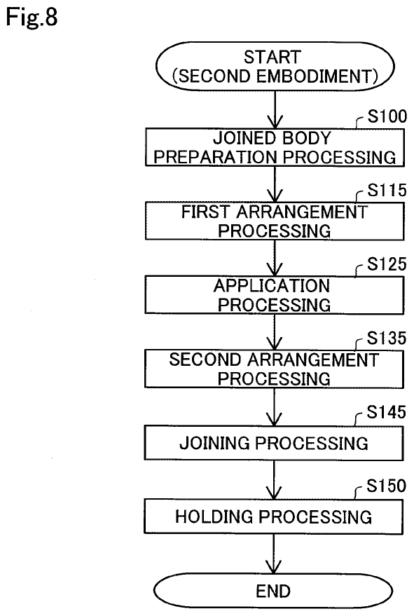

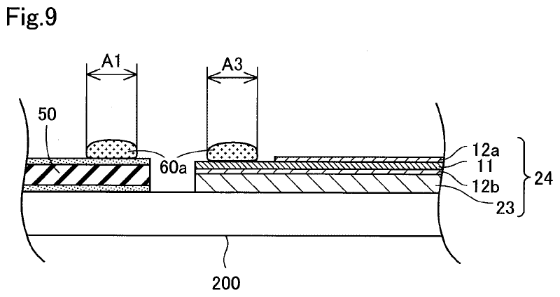

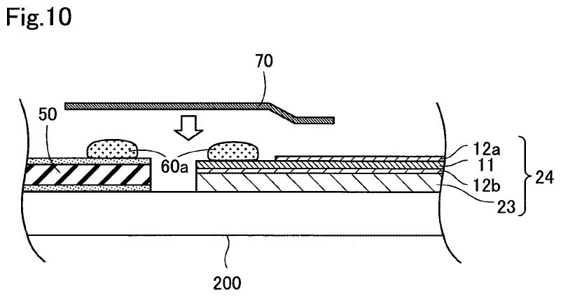

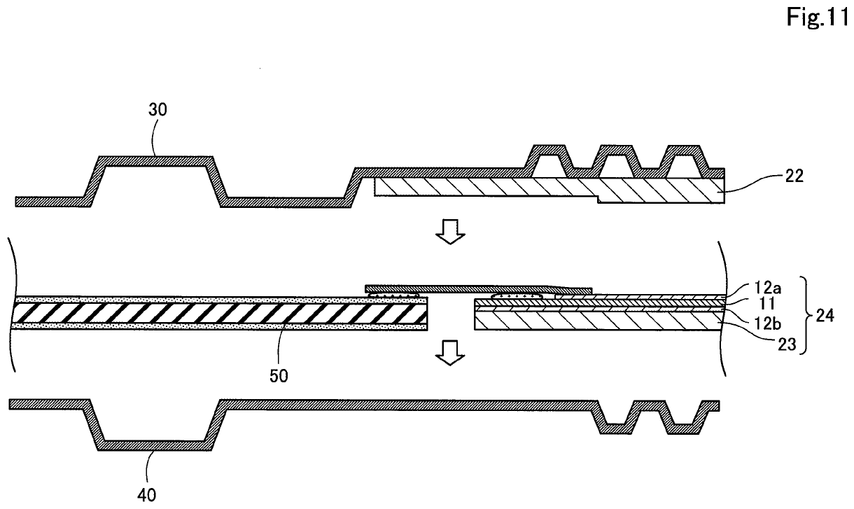

FIG. 8 is a processing flow of a production method of the fuel cell 100A according to the second embodiment. FIG. 9, FIG. 10, and FIG. 11 are explanatory diagrams of processing in the production method. The production method of the fuel cell 100A in the second embodiment is different from the first embodiment in the aspect that an adhesive is applied onto the joined body 24 and the support frame 50 to arrange the cover sheet 70 at Steps S115 to S145, and the other processing is same as that of the first embodiment. Step S100 and Step S150 with the same reference signs are the same processing, and the description thereof is thus omitted.

First arrangement processing is performed at Step S115. In the embodiment, the “first arrangement processing” is processing for arranging the joined body 24 and the support frame 50 on the sucking table 200. To be more specific, the joined body 24 is arranged on the sucking table 200 so that the first catalyst layer 12a is on the upper side and the second gas diffusion layer 23 is on the lower side to be in contact with the sucking table 200. The support frame 50 is arranged around the joined body 24 with the gap G1.

Next, application processing is performed at Step S125. The “application processing” in the embodiment is processing for applying an adhesive onto the upper surfaces of the joined body 24 and the support frame 50 that are arranged on the sucking table 200 at Step S115. FIG. 9 is an explanatory diagram illustrating the application processing. As illustrated in FIG. 9, the adhesive is applied to an end on the support frame 50 side of the electrolyte membrane 11 in the joined body 24, which is in an area to be the third area A3. Moreover, the adhesive is applied to an end on the joined body 24 side of the support frame 50, which is in an area to be the first area A1.

Subsequently, second arrangement processing is performed at Step S135. The “second arrangement processing” is processing for continuously arranging the cover sheet 70 on the adhesive applied on the joined body 24 and on the support frame 50 at the application processing. FIG. 10 is an explanatory diagram of the second arrangement processing. As illustrated in FIG. 10, the cover sheet 70 is arranged to cover the parts on which the adhesive is applied at Step S125.

Next, joining processing is performed at Step S145. For example, UV irradiation is performed from the cover sheet 70 side while vacuum sucking is performed by the sucking table 200. Thus, the adhesive applied at Step S125 is hardened to form the adhesive layer 60a, which joins the joined body 24 and the support frame 50, and the cover sheet 70.

FIG. 11 is an explanatory diagram of the holding processing according to the second embodiment. As illustrated in FIG. 11, in the holding processing at Step S150 of the second embodiment, the support frame 50 and the joined body 24 to which the cover sheet 70 is joined at Step S145 are arranged on the second separator 40, and the first separator 30 on which the first gas diffusion layer 22 is joined is arranged and joined thereon.

In the above-described production method of the fuel cell 100A of the, the cover sheet 70 is arranged continuously on the joined body 24 and the support frame 50 on which the adhesive is applied (see FIG. 10). Thus, the position of the adhesive is not subject to the accuracy of the arrangement of the cover sheet 70 relative to the joined body 24 and the support frame 50. Therefore, it is possible to reduce an area on which the adhesive is applied, as compared with the case where the adhesive is applied onto the cover sheet 70, which reduces an application amount of the adhesive. Moreover, it is possible to prevent air bubbles included in the adhesive. It is also possible to prevent dropping of the adhesive into the gap G1 between the support frame 50 and the membrane electrode assembly 10.

Moreover, the sucking table 200 sucks and joins the joined body 24 and the support frame 50, and the cover sheet 70. The vacuum sucking reduces a pressure of air in the gap G1. Thus, the cover sheet 70 and the gas diffusion layer 22 are brought into close contact with each other. Consequently, it is possible to join the joined body 24 and the support frame 50, and the cover sheet 70 without bringing a tool into contact with the cover sheet 70 and the first gas diffusion layer 22 and pressing them. Moreover, in the production process of the fuel cell 100, it is possible to prevent damages of the electrolyte membrane 11 due to force imposed from the outside.

### C. Other Embodiments

(C1) In the above-described embodiment, the fuel cell is produced using the sucking table 200. Alternatively, there may be used a simple table not performing sucking.

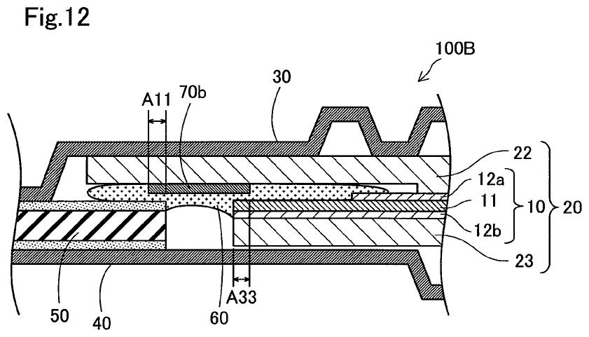

(C2) FIG. 12 is an explanatory diagram illustrating a fuel cell 100B according to another embodiment. In the above-described embodiment, the cover sheet 70 is continuously provided from the first area A1 between the first gas diffusion layer 22 and the support frame 50 to the second area A2 between the first gas diffusion layer 22 and the first catalyst layer 12a, and is larger than the adhesive layer 60. Alternatively, a cover sheet 70b may be continuously provided from the first area A11 between the first gas diffusion layer and the support frame to the third area A33 between the first gas diffusion layer and the electrolyte membrane. The end on the opposite side of the membrane electrode assembly 10 in the first area A11 is closer to the membrane electrode assembly 10 than the end on the opposite side of the membrane electrode assembly 10 in the first area A1. Moreover, the end on the opposite side of the support frame 50 in the third area A33 is closer to the support frame 50 than the end on the opposite side of the support frame 50 in the third area A3. That is, it is possible to reduce the size of the cover sheet 70b, as compared with the first embodiment. The cover sheet 70b only needs to be arranged to cover the first gas diffusion layer 22 facing the gap G1 between the support frame 50 and the membrane electrode assembly 10.

### D. Reference Example

(D1) In the above-described embodiment, the fuel cell 100 includes the adhesive layer 60. Alternatively, the fuel cell 100 may be formed without the adhesive layer 60. In the fuel cell 100, the cover sheet 70 only needs to be adhered to the electrolyte membrane 11 and the support frame 50 so as not to transmit reaction gas. For example, the cover sheet 70 may be directly adhered to the electrolyte membrane 11 and the support frame 50 without the adhesive layer 60 interposed therebetween. The cover sheet 70 is provided using a member not transmitting reaction gas. Therefore, if the cover sheet 70 is adhered to be in close contact with the electrolyte membrane 11 and the support frame 50, reaction gas is not transmitted.

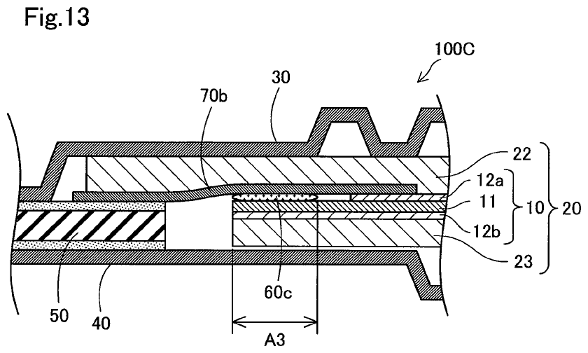

(D2) FIG. 13 is an explanatory diagram illustrating a fuel cell 100C according to the reference example. In the above-described second embodiment, the adhesive layer 60a is arranged on the surface facing the first area A1 of the cover sheet 70 and on the surface facing the third area A3 of the cover sheet 70. Alternatively, the adhesive layer 60c may be arranged only in the third area A3 in the cover sheet 70.

The present disclosure is not limited to the above-described embodiments, and may be achieved with various structures without departing from the scope of the disclosure. For example, the technical features in the embodiments corresponding to the technical features of each aspect of the disclosure may be appropriately replaced or combined in order to solve the above-described problem or achieve a part or all of the above-described effects. Moreover, unless the technical features are explained as necessary in the specification, they may be deleted appropriately.

(1) One aspect of the disclosure provides a fuel cell. The fuel cell includes a membrane electrode assembly that has a first catalyst layer, a second catalyst layer, and an electrolyte membrane arranged between the first catalyst layer and the second catalyst layer, a support frame that is arranged around the membrane electrode assembly, a first gas diffusion layer that is arranged to be in contact with the first catalyst layer and is at least partially arranged beyond an outer edge of the membrane electrode assembly, a second gas diffusion layer that is arranged to be in contact with the second catalyst layer, a pair of separators that hold the first gas diffusion layer, the second gas diffusion layer, and the support frame, and a cover sheet that is provided continuously from a first area between the first gas diffusion layer and the support frame to a second area between the first gas diffusion layer and the electrolyte membrane or the first catalyst layer, and does not transmit reaction gas of the fuel cell, in which the cover sheet is adhered to the support frame and the electrolyte membrane through an adhesive layer so as not to transmit the reaction gas. In the fuel cell of this aspect, the support frame is arranged around the membrane electrode assembly. Then, the cover sheet is adhered to the support frame and the membrane electrode assembly through the adhesive layer. Therefore, as compared with the form in which the support frame and the gas diffusion layer are adhered directly, the gas diffusion layer and the electrolyte membrane are less likely to be damaged due to a difference in thermal expansion of the components and force added from the outside in the production process of the fuel cell or during the operation of the fuel cell. This prevents deterioration of the fuel cell. Meanwhile, in the fuel cell of this aspect, the cover sheet not transmitting reaction gas is adhered to the electrolyte membrane of the membrane electrode assembly and the support frame through the adhesive layer so as not to transmit reaction gas. In this manner, it is possible to suppress mixture of reaction gas on the first catalyst layer side and reaction gas on the second catalyst layer side.

(2) In the fuel cell according to the above-described aspect, an outer marginal portion of the first catalyst layer is on the inner side than an outer marginal portion of the electrolyte membrane, and the second area may be an area between the first gas diffusion layer and the first catalyst layer. In the fuel cell of this aspect, the support frame, the electrolyte membrane, and the first catalyst layer are adhered by the cover sheet. In this manner, the cover sheet covers a part not covered by the first catalyst layer in the electrolyte membrane. Therefore, it is possible to prevent sticks of foreign substances into the electrolyte membrane, and prevent a rupture of the membrane electrode assembly. This prevents deterioration of the fuel cell.

(3) A method of producing the fuel cell according to the above-described aspect includes arranging a joined body having the second gas diffusion layer, the second catalyst layer, the electrolyte membrane, and the first catalyst layer on a table so that the second gas diffusion layer is on the lower side, and arranging the support frame around the joined body on the table, applying an adhesive onto an upper surface of the joined body and an upper surface of the support frame, after the arranging of the support frame, arranging the cover sheet continuously on an adhesive applied on the joined body and an adhesive applied on the support frame, after the applying of the adhesive, and joining the joined body, the support frame on the table, and the cover sheet, after the arranging of the cover sheet. In the production method of this aspect, the cover sheet is arranged on the joined body and the support frame on which the adhesive is applied. Thus, the position of the adhesive is not subject to the accuracy of the arrangement of the cover sheet relative to the joined body and the support frame. Therefore, it is possible to reduce an area on which the adhesive is applied as compared with the case where the adhesive is applied on the cover sheet and then prevent air bubbles included in the adhesive.

(4) In the method of producing the fuel cell according to the above-described aspect, the table is a sucking table that is able to suck a structure placed on the table, and the joining joins the joined body, the support frame, and the cover sheet by sucking the joined body, the support frame, and the cover sheet using the sucking table. In the production method of this aspect, the sucking table sucks and joins the joined body and the support frame, and the cover sheet. Therefore, it is possible to join the joined body and the support frame, and the cover sheet without bringing a tool into contact with the cover sheet and the first gas diffusion layer and pressing them.

The present disclosure may be achieved by various forms, and may be achieved in a form of a fuel cell stack in which a plurality of fuel cell unit cells are stacked, for example.

1. A fuel cell, comprising;
a membrane electrode assembly that includes a first catalyst layer, a second catalyst layer, and an electrolyte membrane arranged between the first catalyst layer and the second catalyst layer;
a support frame that is arranged around the membrane electrode assembly;
a first gas diffusion layer that is arranged to be in contact with the first catalyst layer and is at least partially arranged beyond an outer edge of the membrane electrode assembly;
a second gas diffusion layer that is arranged to be in contact with the second catalyst layer;
a pair of separators that hold the first gas diffusion layer, the second gas diffusion layer, and the support frame; and
a cover sheet that is provided continuously from a first area between the first gas diffusion layer and the support frame to a second area between the first gas diffusion layer and the electrolyte membrane or the first catalyst layer, and does not transmit reaction gas of the fuel cell, wherein
the cover sheet is adhered to the support frame and the electrolyte membrane through an adhesive layer so as not to transmit the reaction gas.

2. The fuel cell according to claim 1, wherein
an outer marginal portion of the first catalyst layer is on an inner side than an outer marginal portion of the electrolyte membrane, and
the second area is an area between the first gas diffusion layer and the first catalyst layer.

3. A method of producing the fuel cell according to claim 1, comprising:
arranging a joined body including the second gas diffusion layer, the second catalyst layer, the electrolyte membrane, and the first catalyst layer on a table so that the second gas diffusion layer is on the lower side, and arranging the support frame around the joined body on the table;
applying an adhesive onto an upper surface of the joined body and an upper surface of the support frame, after the arranging of the support frame;
arranging the cover sheet continuously on an adhesive applied on the joined body and an adhesive applied on the support frame, after the applying of the adhesive; and
joining the joined body, the support frame on the table, and the cover sheet, after the arranging of the cover sheet.

4. The method of producing the fuel cell according to claim 3, wherein
the table is a sucking table that is able to suck a structure placed on the table, and
the joining joins the joined body, the support frame, and the cover sheet by sucking the joined body, the support frame, and the cover sheet using the sucking table.
